(19) United States
(12) Patent Application Publication
(10) Pub. No.: US 2024/0235359 A1
(43) Pub. Date: Jul. 11, 2024

(54) MAGNETICALLY COUPLED DRIVE ARRANGEMENT

(71) Applicant: Max-Planck-Gesellschaft zur Foerderung der Wissenschaften e. V., Muenchen (DE)

(72) Inventor: Sebastian RABIEN, Landshut (DE)

(21) Appl. No.: 18/554,843

(22) PCT Filed: Apr. 14, 2021
(86) PCT No.: PCT/EP2021/059686

§ 371 Date: Oct. 11, 2023

(51) Int. Cl. H02K 49/10; F16H 1/16

(52) U.S. Cl. CPC H02K 49/102; F16H 1/16

(57) ABSTRACT

The present invention relates to a drive arrangement (1), preferably a worm gear drive arrangement (1), with an output element (3) for performing an output movement and a driving element (2) for driving the output element (3), wherein the driving element (2) and the output element (3) are arranged spaced apart (7) from each other in a contactless manner, wherein at least one magnetic unit (4) for generating a magnetic field (MF) is coupled to the driving element (2) for magnetization at least one driving portion (2P1, 2P2) of the driving element (2), wherein the least one driving portion (2P1, 2P2) is configured to transmit the magnetic field (MF, tMF) at least partially to the output element (3) to drive the output element (3) upon a rotational movement of the driving element (2).

The present invention is in the field of magnetic drives and relates to a drive arrangement, preferably a worm gear drive arrangement, with an output element for performing an output movement and a driving element for driving the output element. The driving element and the output element are arranged spaced a part from each other in a contactless manner. At least one magnetic unit for generating a magnetic field is coupled to the driving element for magnetization at least one driving portion of the driving element, wherein the least one driving portion is configured to transmit the magnetic field at least partially to the output element to drive the output element upon a rotational movement of the driving element.

Magnetic driving systems or drives using magnetic fields are already known from the prior art and the concept of magnetic gears was conceived more than a century ago.

For example, published Chinese patent application No. CN 108199561 A describes a non-contact magnetic gear transmission structure for worm gears. Both the gear teeth of the worm wheel and the helical gear teeth of the worm are made of a strong magnetic material. Further, the worm wheel is composed of a non-magnetic worm body. In case of introducing a torque into the worm, the helical gear teeth on the worm pushes the gear teeth on the worm wheel in a non-contacting manner due to the magnetic field in order to rotate the worm wheel. The torque or force is transmitted without contact and without wear.

Publication “Design and Characteristics of A New Magnetic Worm Gear Using Permanent Magnet” by Kikuchi & Tsurumoto, published in IEEE Transactions on Magnetics (Volume: 29, Issue: 6, November 1993, DOI: 10.1109/20.280916) describes a magnetic worm gear using permanent magnets that operates in a non-contact condition in order to reduce noise and avoid wear. The worm consists of worm yoke and tooth according to which the shape of the worm yoke is an ellipsoid and the tooth profile on the worm yoke is spiral-shaped. The worm is in magnetic interaction with a worm wheel which inside surface as the shape of a torus in order to at least partially arrange the worm at the worm wheel in order to drive the worm wheel.

As regards the non-contact, i.e. contactless magnetic worm gear transmission structures known from the prior art, the magnetic fields of the worm and worm wheel are not limited to the area or region of power transmission but surround the entire area or region of both the worm and the worm wheel. For example, this can negatively affect or interfere with components and elements in the immediate vicinity of the worm and/or the worm wheel, in particular in a cryogenic environment (low-temperature environment) or in a vacuum environment. In addition, for example, due to the use of strong magnetic material as permanent magnetic material, there is no possibility to adapt the magnetic field strength of the magnetic field to be transmitted to and/or induced into the worm wheel.

It is hence an object of the present invention to provide an improved drive arrangement using a magnetic field wherein in particular the magnetic field can be adapted and the spatial propagation of the magnetic field can be predetermined and/or limited.

The object is achieved by the drive arrangement according to independent claim 1. Further examples and applications of the present invention result from the dependent claims and are explained in the following description with partial reference to the figures.

A first general aspect of the present invention relates to a drive arrangement, preferably a worm gear drive arrangement, with an output element for performing an output movement, preferably a rotationally output movement, and a driving element for driving, preferably rotationally driving, the output element, wherein the driving element and the output element are arranged spaced a part from each other in a contactless manner, wherein at least one magnetic unit for generating a magnetic field is coupled to the driving element for magnetization or magnetic interaction with at least one driving portion of the driving element, wherein the least one driving portion is configured to transmit and/or induce the magnetic field at least partially to the output element to drive the output element or to set the output element in rotational movement upon a rotational movement of the driving element.

The output element can preferably be a driven element and/or the output movement can be preferably a rotational movement. The driving element can be preferably a rotational driving element. The driving element can be operationally coupled to the output element via a magnetic field being generated by at least one magnetic unit. The driving element and the output element may be preferably spaced apart from each other in a non-touching or non-contacting manner with respect to each other, preferably forming a gap in the range of, for example, 0.001 mm to 50 mm. The at least one magnetic unit may be preferably a separate or a discrete at least one magnetic unit generating the magnetic field. The driving element and the output element or at least portions thereof may be, for example, made of a soft-magnetic material. The driving element may be penetrated by the magnetic field of the at least one magnet unit and—due to its configuration—transmits this magnetic field and/or converts it into a dynamic magnetic field by a rotational movement to drive the output element in a predefined or discrete position.

With the present invention, a magnetic drive arrangement can be provided where, for example, no open and/or undefined moving magnetic field may disturb sensitive measurements and no attraction of ferromagnetic particles may occur that could clog the drive arrangement. The magnetic field may be preferably active or limited in a predefined or predetermined area or region of the driving element and in particular of the output element. Thus, no disturbing or interrupting magnetic forces are emitted.

Further, the drive arrangement cannot, for example, be damaged in over torque situations due to overheating. In addition, there is no generation of jerky or abruptly accelerations in the drive arrangement when compared to classical mechanical gear drive arrangements. For example, the torques and/or forces are transmitted without contact and without wear. Blocking of the components and elements can further be avoided. The drive arrangement can therefore be used as an accuracy gearbox or as an actuator, preferably under special conditions as exemplary described below.

In addition, for example, the drive arrangement according to the present invention does not need or require periodic lubrication and/or maintenance services. This makes it possible that the drive arrangement, for example, can be used in a special environment such as vacuum or cryogenic or high purity environment which require increased accuracy as under room temperature conditions. There may be no clamping or inhibition.

Preferably, the drive arrangement can be used for precise movements, for example for filter plane masks or filter wheels in infrared cameras, spectrometers or the like, since a high gear or transmission ratio can be reached in one stage, for example, up to 1:600.

It is also possible that the main components and/or elements as described above and needed for the drive arrangement may be constructed and/or manufactured comparatively simple and less complex. For example, no expensive run-in worm gear material is required. Overall, the number of components and elements required is less.

According to a further aspect of the invention, the at least one driving portion may be configured essentially cylindrically and/or may comprise at least one protrusion or at least one flank being configured at least partially circumferential, and/or wherein the at least one driving portion may be configured gear rack-shaped in a cross section, preferably in an axial section.

The at least one protrusion or the at least one flank may be, for example, configured tooth-shaped in a cross section. The at least one protrusion or the at least one flank may be configured as a circumferential closed disc or as a circumferential helix extending in an axial direction which will be described in further detail below.

It is possible that the at least one protrusion or the at least one flank can be configured closed in itself, or can extend helical-shaped or spiral-shaped in an axial direction of the driving element, wherein preferably the pitch angle of at least one protrusion or the at least one flank may be in a range of 0.1° to 50°, more preferably in a range of 0.1° to 2°.

This allows, for example, that a static magnetic field, being generated by the at least one magnetic unit, is transmitted over the at least one protrusion or the at least one flank and effectively converted into a dynamic magnetic field generating torques and/or forces on the output element to drive the output element. In other words, a static magnetic field of the at least one magnetic unit can be processed in a dynamic magnetic field that is able to generate torques and/or forces to the output element due to magnetization of at least an output element portion.

It is further possible, for example, that the driving element can be driven by the output element due to a wear free arrangement of the driving element towards the output element and correspondingly selected pitch angle, for example more than 25°.

According to a further aspect of the invention, the at least one driving portion may be configured threaded bolt-shaped or cylindrical worm-shaped, preferably with at least one protrusion or with at least one flank or a plurality of protrusions or a plurality of flanks being arranged circumferential and/or extending in an axial direction of the driving element.

The axial direction may be a longitudinal direction of the driving element.

It is possible that the at least one protrusion or the at least one flank may comprise an essentially rectangular, essentially trapezoidal or essentially triangular contour in a cross section, preferably in an axial section, and/or wherein the at least one protrusion or the at least one flank may be surrounded at least partially by a filler material, preferably along an axial direction of the driving element, wherein the filler material may be preferably a non-magnetizable or a non-magnetic material.

The filler material can be, for example, aluminum or an aluminum-based alloy, a CTE matched aluminum-silicon alloy, polymers or the like.

The use of a filler material can lead, for example, to a closed and/or continuous outer surface of the at least one driving portion and/or the driving element. This facilitates, for example, cleaning for high purity environments. With the filler material and thus reduced outer surface, it is further possible, for example, to reduce evacuation periods in vacuum environments.

According to a further aspect of the invention, at least one output element portion of the output element, being driven by the at least partially transmitted and/or induced magnetic field, may be configured essentially identically or at least similarly or complementary to the at least one driving portion of the driving element.

In other words, at least the at least one output element portion may comprise at least one protrusion or at least one flank and/or filler material as disclosed herein. The at least one output element portion may be configured circumferential.

It is possible that the output element may be configured as a spur wheel and can comprise at least one protrusion or at least one flank or preferably a plurality of protrusions or a plurality of flanks being arranged around the outer circumference of the output element.

According to a further aspect of the invention, the driving element and/or at least the at least one driving portion may be arranged in a housing, wherein the housing may be preferably enclosed and/or sealed towards at least the output element, or wherein a partition wall can be arranged between the driving element, preferably the at least one driving portion, and the output element.

The housing may at least partially surround the driving element and/or at least the at least one driving portion. The housing may be, for example, configured as a thin-walled non-magnetic tube.

In other words, the housing may be configured essentially cylindrically. It is also possible that a motor driving the driving element and the driving element may be arranged within a housing. Thus, a complete separation towards the output element and/or towards the at least one magnetic unit can be reached. This allows, for example, that the output element can be arranged in a different environment than the motor and the driving element and/or the at least one magnetic unit. For example, the output element can be arranged within a vacuum and/or high purity environment and the motor, the driving element and the at least one magnetic unit can be arranged outside such an environment. This allows, for example, the use of a conventional motor which requires lubrication and/or regular maintenance services.

It is possible that the at least one magnetic unit may be displaceable or movably mounted with reference to the driving element, preferably with reference to the at least one driving portion, for at least adjusting the magnetic field strength of the magnetic field.

In other words, the distance or the position of the at least one magnetic unit may be variably adjustable with reference to the driving portion. It is further possible that the at least one magnetic unit is configured to be arranged at different positions on the driving element, preferably in circumferential direction.

According to a further aspect of the invention, the driving element may be displaceable or movably mounted with reference to the output element and/or with reference to the at least one magnetic unit for adjusting the at least partially transmitted and/or induced magnetic field.

It is possible that the at least one magnetic unit may be configured essentially C-shaped, essentially U-shaped and/or at least partially essentially cylindrically, and/or that the at least one magnetic unit may comprise a permanent magnet or an electromagnet.

The use of a permanent magnet or a plurality of permanent magnets may be very inexpensive.

According to a further aspect of the present invention, wherein in a view, preferably in a cross section when viewed in an axial direction of the driving element, the at least one driving portion can comprise an essentially circular contour, wherein the diameter of the at least one driving portion may be at least equal to or greater than a thickness of the at least one output element portion being assigned to the at least one driving portion.

It is possible the driving element can comprise a first driving portion and a second driving portion as disclosed herein, wherein the first driving portion and the second driving portion may be spaced apart from each other in an axial direction of the driving element.

According to a further aspect of the present invention, the driving element can comprise a shaft and wherein the first driving portion and/or the second driving portion may be plugged and/or pressed onto the shaft, or can be integrally formed in one piece with the shaft.

This can ensure, for example, ease of manufacture of the driving element.

It is possible that a filler material may be arranged, preferably molded or glued, between the first driving portion and the second driving portion.

According to a further aspect of the present invention, the rotational axis of the driving element and the rotational axis of the output element may be spaced apart from each other and may intersect or cross at essentially 90°. It is alternatively possible that the rotational axis of the driving element and the rotational axis of the output element may be arranged or intersect at an oblique angle to each other, for example 70°. At least the output element, preferably the at least one output element portion, may be configured at least partially helical toothed or helical cut.

It is possible that the output element may be configured at least partially spur gear-shaped or gear rack-shaped.

This allows, for example, the generation of a linear or translational movement of the output element.

According to a further aspect of the present invention, the driving element and the output element may be arranged spaced a part from each other in a contactless manner forming a gap with the gap being between 0.001 mm and 50 mm wide at the narrowest point or position between the at least one driving portion and the output element, preferably at least one output element portion of the output element.

The dimension of the gap can be relatively small compared to a distance between a protrusion or flank to a further protrusion or flank being adjacent to it.

It is possible that the driving element may be arranged at least partially between the output element and the at least one magnetic unit, and/or the driving element can be configured to be rotationally driven, preferably by an electric stepper motor, at two ends being arranged diametrically opposed.

The use of a stepper motor allows, for example, adjusting the output element to discrete or predefined positions.

In addition, the drive arrangement is self-holding, preferably at such a predefined position, and the stepper motor can thus be switched off.

According to a further aspect of the present invention, at least one sensor unit may be configured and/or arranged for detecting at least the magnetic field strength and/or the magnetic flux density of the magnetic field between the at least one magnetic unit and the at least one driving portion and/or between the at least one driving portion and the output element, preferably at least one output element portion of the output element.

It is further possible that the at least one sensor unit is configured to detect the position, preferably the rotational position, of the output element and/or the driving element. The driving element can be driven by a motor as disclosed herein wherein the motor and the at least one senor unit may be part of a control system of closed loop configuration comprising further components and elements such as a digital signal processing unit and the like.

A further general aspect of the present invention relates to a method of driving the output element by the driving element of the drive arrangement as disclosed herein, wherein the at least one driving portion is transmitting the magnetic field at least partially to drive the output element when the driving element rotationally moves.

In order to avoid repetition, features which are purely directed to the drive arrangement according to the present invention and/or disclosed in connection therewith should also be considered as disclosed according to the method and be claimable and vice versa.

The previously described examples and features of the present invention can be combined with each other in any way.

Further or other details and advantageous effects of the present invention are described in more detail below with reference to the attached figures:

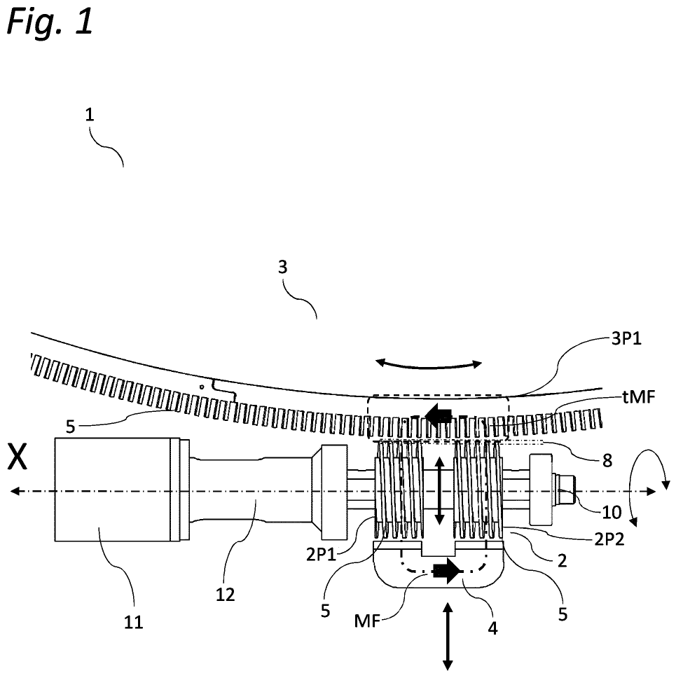

FIG. 1 illustrates a front view of a first example of the drive arrangement according to the present invention;

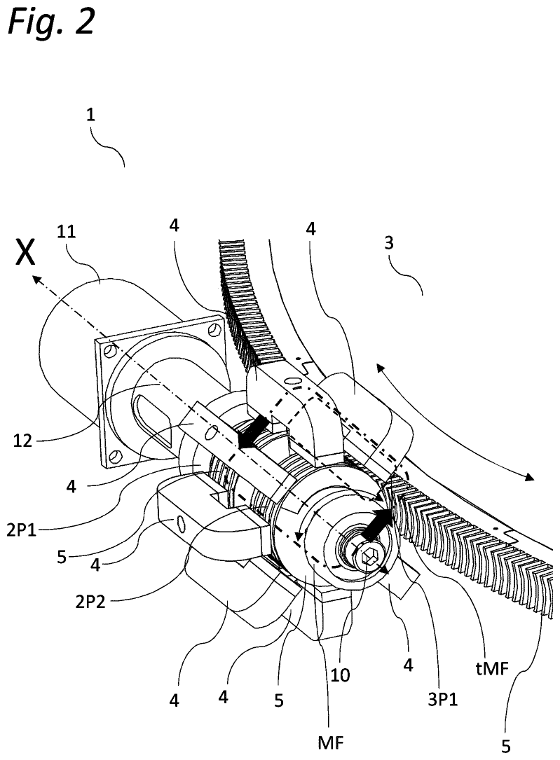

FIG. 2 illustrates a perspective view of a second example of the drive arrangement according to the present invention;

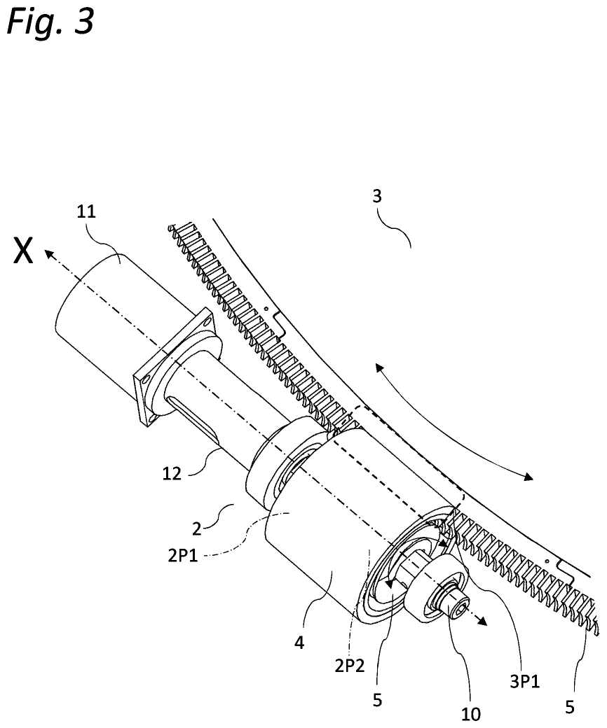

FIG. 3 illustrates a perspective view of a third example of the drive arrangement according to the present invention;

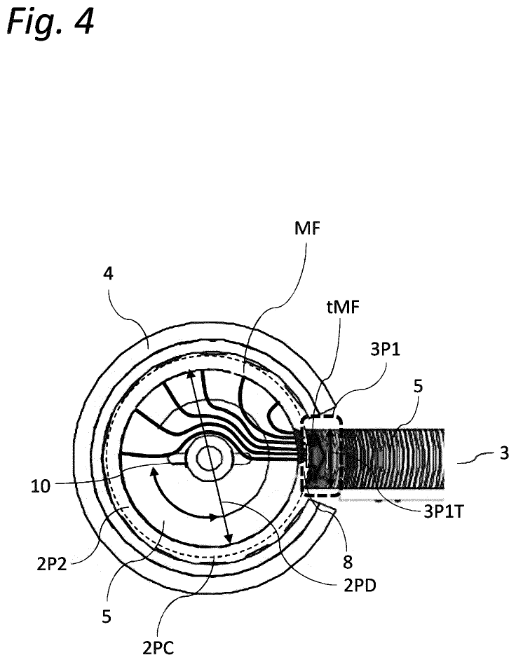

FIG. 4 illustrates a side view of the third example of the drive arrangement as illustrated in FIG. 3;

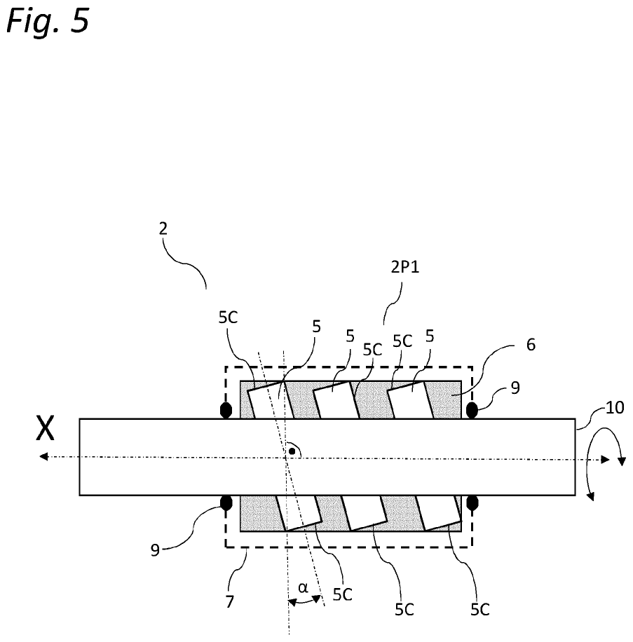

FIG. 5 illustrates an example of a driving element.

Identical or functionally equivalent components or elements are marked or labeled in the figures with the same reference signs. For their explanation, reference is also made to the description of other examples and/or figures in order to avoid repetition.

The following detailed description of the examples shown in the figures serves as a closer illustration or exemplification and is in no way intended to limit the scope of the present invention.

FIG. 1 illustrates a front view of a first example of the drive arrangement 1 according to the present invention. The drive arrangement 1 comprises in particular a driving element 2, an output element 3 and a magnet unit 4. The driving element 2 drives the output element 3 and the output element 3 performs an output movement, preferably a rotational movement, which is described in further detail below.

The driving element 2 comprises a shaft 10 which is releasable coupled to a motor 11 via a clutch 12. The motor 11 can be an electric motor such as stepper motor. The motor 11 can be controlled by a controlling device in closed-closed loop configuration (not shown in the figures for reasons of clarity).

A first driving portion 2P1 and a second driving portion 2P2 are mounted on the shaft 10. The first driving portion 2P1 and/or the second driving portion 2P2 can be plugged and/or pressed onto the shaft 10. It is possible that alternatively the first driving portion 2P1 and/or the second driving portion 2P2 are integrally formed in one piece with the shaft 10. It is possible that the first driving portion 2P1 is configured essentially identically or at least similar to the second driving portion 2P2. The first driving portion 2P1 and the second driving portion 2P2 are spaced apart from each other in an axial direction X of the driving element 2 and thus the shaft 10 of the driving element 2. The axial direction X of the driving element 2 can be considered as longitudinal direction, i.e. the direction of the longest extension of the driving element 2.

Both the first driving portion 2P1 and the second driving portion 2P2 can be configured threaded bolt-shaped or cylindrical worm-shaped. The first driving portion 2P1 and the second driving portion 2P2 each comprises a protrusion or flank 5 which is configured circumferential and extends helical-shaped or spiral-shaped in the axial direction X of the driving element 2. In other words, the protrusion or flank 5 extends away from the shaft and in the direction of shaft 10 in a disc-shaped or helical manner. In an alternative example of the present invention, it is possible that a plurality of protrusions or flanks 5 are arranged onto the shaft 10 in an axial direction X and are spaced apart from each other. Then, each protrusion or flank 5 is configured circumferential with reference to the shaft 10 and further configured closed in itself, for example as a disc.

The protrusion or flank 5 is preferably arranged under formation of a pitch angle α (see FIG. 5 for further illustration). The pitch angle α can be in a range of 0.1° to 50°, or can be more preferably in a range of 0.1° to 2°. The driving element 2 can thus be preferably configured at least partially as a worm. The shaft 10 and/or the first driving portion 2P1 and/or the second driving portion 2P2 are preferably made of a soft-magnetic material, i.e. a material which is magnetizable or can be magnetized. The soft-magnetic material can be metal based.

The output element 3 is a driven element and can be configured as a worm wheel or a spur wheel and can comprise at least one flank 5 or preferably a plurality of flanks 5 being arranged around the outer circumference of the output element 3. It is possible that at least one output element portion 3P1 is configured essentially identically or at least similarly or complementary to at least one of the first driving portion 2P1 and/or the second driving portion 2P2. The output element 3 is rotatable supported and can thus perform rotational movements. The output element 3 can be used as an adjustment element for a kinematic system consisting, for example, of beams, wheels and/or rods. The drive mechanism or the drive principle between the driving element 2 and the output element 3 is described in further detail below.

The driving element 2 with its first driving portion 2P1 and second driving portion 2P2 and the output element 3 are spaced apart from each other in a contactless manner forming a gap 8. In other words, there is no mechanical contact between the driving element 2 and the output element 3 in order to transmit forces and/or torques. The gap 8 can be, for example, between 0.2 mm to 2 mm wide.

At least one magnetic unit 4 for generating a magnetic field MF is coupled to and/or arranged to the driving element 2, preferably to the first driving portion 2P1 and the second driving portion 2P2. The at least one magnetic unit 4 can comprise a permanent magnet or, in the alternative, an electromagnet. The at least one magnetic unit 4 can be configured C-shaped or U-shaped. The at least one magnetic unit 4 as illustrated in FIG. 1 is more or less configured as a horseshoe magnet with a south pole and a north pole representing areas of which the magnetic field strength of the magnetic field MF is particularly high. The at least one magnetic unit 4 is arranged accordingly such that the two magnetic poles are in the immediate vicinity of the first driving portion 2P1 and the second driving portion 2P2 thus transmitting and/or inducing at least partially the magnetic field MF into the first driving element 2P1 and the second driving element 2P2.

Since the at least one magnetic unit 4 comprises a permanent magnet, the magnetic field MF generated by the at least one magnetic unit 4 is a static magnetic field, i.e. of static kind and is thus not time-varying.

The motor 11 when switched on can cause the shaft 10 of the driving element 2 in rotational movement via clutch 12. Thus, the first driving portion 2P1 and the second driving portion 2P2 with the flanks 5 are set in a rotational movement accordingly. In other words, the shaft 10 begins to rotate once the motor 11 is started.

Due to the rotational movement of the first driving portion 2P1 and the second driving portion 2P2 the helical-shaped flanks 5 protruding from the shaft 10 rotate on the one hand and, on the other hand, the flanks 5 vary their position towards or with reference to the output element 3 and preferably the output element portion 3P1 being in the immediate vicinity to the first driving portion 2P1 and the second driving portion 2P2 along the axial direction X. In other words, due to rotational movement of the shaft 10, the first driving portion 2P1 and the second driving portion 2P2 perform a screwing movement with their flanks 5. The screwing movement now causes a time-varying and/or locally change of the magnetic field MF being transmitted and/or induced at least partially to the driving element 2 by the at least one magnetic unit 4 and further transmitted to and/or induced into the output element portion 3P1 of the output element 3. The magnetic field tMF is transferred to and/or induced into the output element portion 3P1 of the output element 3 in such a way that it changes at least partially in time and/or location such that the output element 3 begins to rotate to reach a predefined position. In other words, a resulting force and/or a resulting torque is transmitted to the output element 3 from the at least magnet unit 4 via the driving element 2. However, the magnetic field MF and the transmitted and/or induced magnetic field tMF remains locally mainly in the driving element 2 and the output element portion 3P1, i.e. the drive arrangement 1 is characterized in that the magnetic field MF and the transmitted and/or induced magnetic field tMF can be kept locally limited or predefined.

FIG. 2 illustrates a perspective view of a second example of the drive arrangement 1 according to the present invention.

The drive arrangement 1 comprises a plurality of magnetic units 4. The driving element 2 is configured cylindrically and comprises a shaft 10 and two driving portions 2P1, 2P1 with flanks 5 being releasable mounted onto the shaft 10 and spaced apart from each other. In detail, seven magnetic units 4 are arranged around the circumference of the driving element 2 and preferably around the outer side of the flanks 5 of the first driving portion 2P1 and the second driving portion 2P2.

Each magnetic unit 4 comprises a permanent magnet and is configured C-shaped such that the north pole and the south pole are arranged in the immediate vicinity of the two driving portions 2P1, 2P2 forming a gap. Due to the plurality of discrete or separate magnetic units 4 with their respective magnetic fields MF, the transmitted and/or induced magnetic field tMF, i.e. the magnetic field strength and/or the magnetic flux of the magnetic field tMF is significantly increased. The magnetic field MF and the magnetic field tMF transmitted to and/or induced into the output element portion 3P1 of the output element 3 are displayed schematically in FIG. 2.

The drive mechanism of the drive arrangement 1 as illustrated in FIG. 2 functions analogously to the first example of the drive arrangement 1 as illustrated in FIG. 1.

FIG. 3 illustrates a perspective view of a third example of the drive arrangement 1 according to the present invention.

With regard to the first and the second example as illustrated in FIGS. 1 and 2, the third example of the drive arrangement 1 as illustrated in FIG. 3 comprises again a motor 11 being coupled to a driving element 2 via clutch 12. The driving element 2 is configured cylindrically and comprises a first driving portion 2P1 and a second driving portion 2P2 being mounted onto the shaft 10 and being arranged spaced apart from each other.

The drive arrangement 1 further comprises a magnetic unit 4. The magnetic unit 4 is configured at least partially cylindrically and extends along the axial direction X. In addition, the magnetic unit 4 surrounds at least partially a portion of the driving unit 2, i.e. the first driving portion 2P1 and the second driving portion 2P2. The flanks 5 of the first and the second driving portions 2P1, 2P2 are not recognizably illustrated in FIG. 3.

A schematic representation of the magnetic field MF generated by the magnet unit 4 and the magnetic field tMF transmitted to and/or induced into the output element portion 3P1 of the output element 3 are not shown for reasons of clarity.

With the configuration of the magnetic unit 4 as at least partially cylindrically and the arrangement of a portion or section of the driving element 2 with preferably the first and the second driving portions 2P1, 2P2 being surrounded by the magnetic unit 4 and the output element portion 3P1, it is possible to keep the magnetic field MF and in particular the transmitted and/or induced magnetic field tMF localized which is further illustrated in FIG. 4.

FIG. 4 illustrates a side view of the third example of the drive arrangement 1 as illustrated in FIG. 3.

In the view in FIG. 4 which is a view in the axial direction X, the magnetic unit 4 has a C-shaped contour and surrounds the driving element 2, i.e. the first driving portion 2P1 and the second driving portion 2P2, together with the output element portion 3P1 which is configured complementary to the first driving portion 2P1 and/or the second driving portion 2P2.

It has to be noted that the output element portion 3P1 is the respective portion of the output element 3 on which the transmitted and/or induced magnetic field tMF acts in order to transmit forces and/or torques and to drive the output element 3 rotationally or to cause the output element 3 to perform a rotational movement.

The magnetic unit 4 generates a magnetic field MF which is transmitted to and/or induced into the first driving portion 2P1 and the second driving portion 2P2 and further transmitted to and/or induced into the output element portion 3P1 in order to drive the output element 3 upon a rotational movement of the driving element 2. Analog to the first and the second example of the drive arrangement 1 as illustrated in FIGS. 1 and 2, the driving element 2 of the third example of the drive arrangement 1 as illustrated in FIGS. 3 and 4 can be driven preferably by a motor 11, for example, an electric motor 11 such as a stepper motor.

In the view as illustrated in FIG. 4, the first driving portion 2P1 and the second driving portion 2P2 each comprise an essentially circular contour 2PC wherein the diameter 2PD of the first driving portion 2P1 and/or the second driving portion 2P2 in the view is greater than the thickness 3P1T of the output element portion 3P1 which is assigned to the first driving portion 2P1 and the second driving portion 2P2. In other words, the flanks 5 of the first driving portion 2P1 and the second driving portion 2P2 extend oppositely away from each other such that the corresponding distance of the respective outer surfaces or outer contours in that view is greater than the thickness 3P1T of the output element portion 3P1.

FIG. 4 illustrates schematically very clearly the propagation of the magnetic field MF and the transmitted and/or induced magnetic field tMF.

FIG. 5 illustrates schematically a further example of a driving element 2 with a first driving portion 2P1. The driving element 2 comprises a shaft 10 of essentially cylindrical configuration. The shaft 10 is configured to be rotationally driven at two ends being arranged diametrically opposed. The shaft 10 further comprises three protrusions or flanks 5 forming the first driving portion 2P1.

Each flank 5 is configured circumferential and closed in itself. Each flank 5 is made of a soft-magnetic material in order to transmit and/or induce the magnetic field MF or at least partially the magnetic field MF to the output element 3 (not shown in FIG. 5).

In the cross-section view, each flank 5 comprises an essentially trapezoidal contour 5C. In an alternative example of the driving element 2, it is possible that a flank 5 comprises an essentially rectangular or essentially triangular contour in a cross section, i.e. in a cross-sectional view. Each flank 5 is arranged obliquely to the axial direction X with the formation of a pitch angle α which is equal to or less than 5°, more preferably equal to or less than 2° (in FIG. 5 one pitch angle α is illustrated exemplary). In other words, the circumferential flanks 5, which are configured disc-shaped, are arranged on the shaft 10 obliquely to the axial direction X of the shaft 10.

The flanks 5 can be surrounded at least partially by a filler material 6, preferably in axial direction X of the driving element 2. The filler material 6 can preferably be a dimensionally stable and/or low-temperature stable non-magnetizable material such as a plastic material.

It is possible that the filler material 6 is also arranged between hollow spaces or cavities of the flanks 5 of the first driving portion 2P1 and the second driving portion 2P2 of the first to the third example of the drive arrangement 1 as illustrated in FIGS. 1 to 4.

It is possible that the driving element 2 and/or at least the first driving portion 2P1 is arranged in a housing 7, wherein the housing 7 is preferably enclosed and/or sealed by means of seals 9 towards at least the output element 3 (not shown in FIG. 5). This allows an output element 3 (not shown in FIG. 5) to be driven in a different environment then the driving element 2 via the transmitted and/or induced magnetic field tMF (not shown in FIG. 5).

The at least one magnetic unit 4 can be arranged and/or mounted displaceable or movably with reference to the driving element 2, preferably with reference to the at least one driving portion 2P1, 2P2, for at least adjusting the magnetic field strength of the magnetic field MF and thus the transmitted and/or induced magnetic field tMF which is proportional to the forces and/or torques transmitted to the output element 3.

It is further possible that at least one sensor unit (not shown in the figures for reasons of clarity) is configured for detecting at least the magnetic field strength and/or the magnetic flux density of the magnetic field MF between the at least one magnetic unit 4 and the at least one driving portion 2P1, 2P2 and/or between the at least one driving portion 2P1, 2P2 and the output element 3, preferably at least one output element portion 3P1 of the output element 3. It is further possible that the at least one sensor unit is configured to detect a distance between a reference point of the magnetic unit 4 and a reference point of the driving element 2 in order to allow an adjustment of the position between the magnetic unit 4 and the at least one driving element 2.

The at least one sensor unit can further be configured to detect the rotational position of the output element 3 in order to adjust the positon of the output element 3 accordingly as disclosed herein via using a control circuit and/or control device of closed-loop configuration.

The present invention is not limited to the examples as described above. Rather, a large number of variants and modifications are possible, which also make use of the inventive idea and therefore fall within the scope of protection.

The present invention can be realized at least partially in hardware and/or software. The present invention can be transferred to at least one computer program product as regards preferably controlling the motor for driving the driving element.

Preferably, the present invention also claims protection for the subject matter and the features of the sub-claims independently of the claims referred to.

### LIST OF REFERENCE SIGNS

1 drive arrangement
2 driving element
2P1 first driving portion
2P2 second driving portion
2PC contour of the first driving portion and/or the second driving portion in a view
2PD diameter of circular contour in a view
3 output element (worm wheel, spur gear)
3P1 output element portion (of output element)
3P1T thickness of output element portion
4 magnetic unit
5 flank
5C contour (of flank)
6 filler material
7 housing
8 gap
9 seal
10 shaft
11 motor
12 clutch
MF magnetic field
tMF transmitted/induced magnetic field
X axial direction
α pitch angle

1. A drive arrangement with an output element for performing an output movement and a driving element for driving the output element, wherein the driving element and the output element are arranged spaced apart from each other in a contactless manner, wherein at least one magnetic unit for generating a magnetic field is coupled to the driving element for magnetization at least one driving portion of the driving element, wherein the least one driving portion is configured to transmit the magnetic field at least partially to the output element to drive the output element upon a rotational movement of the driving element.

2. The drive arrangement according to claim 1, wherein the at least one driving portion is configured cylindrically and comprises at least one flank being configured at least partially circumferential, or wherein the at least one driving portion is configured gear rack-shaped in a cross-section.

3. The drive arrangement according to claim 2, wherein the at least one flank is configured closed in itself, or extends helical-shaped or spiral-shaped in an axial direction of the driving element.

4. The drive arrangement according to claim 2, wherein the at least one driving portion is configured threaded bolt-shaped or cylindrical worm-shaped.

5. The drive arrangement according to claim 2,
wherein the at least one flank comprises a rectangular, trapezoidal or triangular contour in a cross-section, or wherein the at least one flank is surrounded at least partially by a filler material.

6. The drive arrangement according to claim 1,
wherein at least one output element portion of the output element, being driven by the at least partially transmitted magnetic field, is configured identically or similarly or complementary to the at least one driving portion of the driving element.

7. The drive arrangement according to claim 1,
wherein the output element is configured as a spur wheel and comprises at least one flank or a plurality of flanks being arranged around an outer circumference of the output element.

8. The drive arrangement according to claim 1,
wherein the driving element or at least the at least one driving portion is arranged in a housing, wherein the housing is enclosed or sealed towards at least the output element, or wherein a partition wall is arranged between the driving element and the output element.

9. The drive arrangement according to claim 1,
wherein the at least one magnetic unit is displaceable mounted with reference to the driving element for at least adjusting a magnetic field strength of the magnetic field.

10. The drive arrangement according to claim 1,
wherein the driving element is displaceable mounted with reference to the output element or with reference to the at least one magnetic unit for adjusting the at least partially transmitted magnetic field.

11. The drive arrangement according to claim 1,
wherein the at least one magnetic unit is configured C-shaped, U-shaped or at least partially cylindrically, or wherein the at least one magnetic unit comprises a permanent magnet or an electromagnet.

12. The drive arrangement according to claim 1,
wherein in a view the at least one driving portion comprises a circular contour, wherein the diameter of the at least one driving portion is at least equal to or greater than a thickness of the at least one output element portion being assigned to the at least one driving portion.

13. The drive arrangement according to claim 1,
wherein the driving element comprises a first driving portion and a second driving portion, wherein the first driving portion and the second driving portion are spaced apart from each other in an axial direction of the driving element.

14. The drive arrangement according to claim 13,
wherein the driving element comprises a shaft and wherein the first driving portion or the second driving portion is plugged or pressed onto the shaft, or is integrally formed in one piece with the shaft.

15. The drive arrangement according to claim 13, wherein a filler material is arranged between the first driving portion and the second driving portion.

16. The drive arrangement according to claim 1,
wherein a rotational axis of the driving element and a rotational axis of the output element are spaced apart from each other and intersect at 90° or at an oblique angle.

17. The drive arrangement according to claim 1,
wherein the output element is configured at least partially spur gear-shaped or gear rack-shaped.

18. The drive arrangement according to claim 1,
wherein the driving element and the output element are arranged spaced apart from each other in a contactless manner forming a gap with the gap being from 0.001 mm to 50 mm wide at a narrowest point between the at least one driving portion the output element.

19. The drive arrangement according to claim 1,
wherein the driving element is arranged at least partially between the output element and the at least one magnetic unit or wherein the driving element is configured to be rotationally driven at two ends being arranged diametrically opposed.

20. The drive arrangement according to claim 1,
wherein at least one sensor unit is configured for detecting at least a magnetic field strength or a magnetic flux density of the magnetic field between the at least one magnetic unit and the at least one driving portion or between the at least one driving portion and the output element.

21. The drive arrangement according to claim 3,
wherein a pitch angle of the at least one flank is in a range of 0.1° to 50°, or in a range of 0.1° to 2°.

22. The drive arrangement according to claim 5,
wherein the filler material is a non-magnetizable material.
